(19) United States
(12) Patent Application Publication
(10) Pub. No.: US 2017/0361204 A1
(43) Pub. Date: Dec. 21, 2017

(54) WHEEL BEARING

(71) Applicant: Andrew Bartlett, MANLY WEST (AU)

(72) Inventor: Andrew Bartlett, MANLY WEST (AU)

(21) Appl. No.: 15/623,941

(22) Filed: Jun. 15, 2017

(30) Foreign Application Priority Data
Jun. 16, 2016 (AU) 2016902332

(51) Int. Cl. A63C 17/01; B60B 27/02; F16C 19/16

(52) U.S. Cl. CPC A63C 17/014; F16C 19/163; A63C 17/017; B60B 27/02; F16C 2326/02

(57) ABSTRACT

A wheel bearing having a cup, a cone and a washer. The cone is of a complementary shape to the cup and the washer abuts a surface of the cone. Each of the cup, the cone and the washer are made from a self-lubricating polymer.

### FIELD OF THE INVENTION

The present invention relates to a wheel bearing. In particular, although not exclusively, the invention relates to a bearing for a skateboard wheel and a skateboard wheel assembly. However, it will be appreciated that the wheel assembly can be used on other wheeled devices.

### BACKGROUND TO THE INVENTION

Reference to background art herein is not to be construed as an admission that such art constitutes common general knowledge.

A large number of people, many of them children, suffer injuries whilst attempting to learn to ride a skateboard or similar wheeled device. Similarly, even more experienced riders are injured due to falls of numerous kinds but in this instance, particularly from the tendency of such wheeled devices to escape forward from under the rider rendering the rider prone to wrist, arm, spinal or head injuries.

Skateboards and similar wheeled devices are traditionally fitted with highly effective ball bearings in the wheels. These ball bearings have virtually no resistance to facilitate rolling in any condition, either static or dynamic.

As soon as a rider places any weight onto the riding deck of the board, the board has a natural tendency to roll and accelerate under the force of the rider's weight. If the rider is not quick and skilful enough to get both feet onto the board and balance between the two axles, the board has a tendency not only to move away from under the rider taking the rider's feet with it, but as the rider's weight moves behind the rear axle the downward and forward weight of the rider causes the board to accelerate rapidly propelling the rider's upper body and head backwards towards the ground.

### OBJECT OF THE INVENTION

It is a preferred object of the present invention to provide an improved wheel bearing and skateboard wheel assembly that addresses, or at least ameliorates one or more of the aforementioned problems of the prior art and/or provides a useful or commercial alternative.

Other preferred embodiments of the present invention will become apparent from the following description.

### SUMMARY OF THE INVENTION

In one form, although not necessarily the only or broadest form, the invention resides in a wheel bearing comprising:

a cup;

a cone received within the cup, the cone being of a complementary shape to the cup; and

a washer, the washer abutting a surface of the cone, wherein the cup, the cone and the washer each comprise a self-lubricating polymer.

In a second form, although not necessarily the only or broadest form, the invention resides in a skateboard wheel assembly comprising:

a wheel;

two wheel bearings diametrically opposed on two sides of the wheel, each wheel bearing including:
a cup;
a cone received within the cup, the cone being of a complementary shape to the cup; and
a washer, the washer abutting a surface of the cone,

wherein the cup, the cone and the washer each comprise a self-lubricating polymer.

Preferably, a spacer is mounted between the two wheel bearings. More preferably, the spacer abuts the two wheel bearings.

Preferably, the washer includes a raised outer lip.

Preferably, the self-lubricating polymer includes acetal and ertalon.

Preferably, the cup includes a tapered inner side wall.

Preferably, the cone includes a tapered outer side wall complementary to the tapered inner side wall of the cup.

Preferably, the cone includes an upper face and a lower face at opposed ends of the cone.

Preferably, the tapered outer side wall extends between the upper face and the lower face of the cone. More preferably, the tapered outer side wall of the cone extends from the lower face to the upper face at an angle of between 45° to 85° relative to the lower face. Even more preferably, the tapered outer side wall of the cone extends from the lower face to the upper face at an angle of between 55° to 75° relative to the lower face. Suitably, the tapered outer side wall of the cone extends from the lower face to the upper face at an angle of between 65° to 75° relative to the lower face.

Preferably, the lower face of the cone abuts the washer.

Preferably, the cone is frustoconical.

In another form, although not necessarily the only or broadest form, the invention resides in a method for assembling a skateboard wheel comprising:

fitting a first cup into a first housing recess of a wheel;

fitting a first cone within the first cup;

fitting a first washer to the first cone, wherein the first washer abuts a surface of the first cone;

fitting a second cup into a second housing recess of the wheel, the first housing recess opposite the second recess;

fitting a second cone within the second cup, wherein the second cone abuts the first cone;

fitting a second washer to the second cone, wherein the second washer abuts a surface of the second cone.

Preferably, the method further comprises the step of fitting a spacer within the wheel, wherein the spacer abuts the first cone and the second cone.

Preferably, the method further comprises the step of fitting the skateboard wheel to an axle.

Preferably, the method further comprises the step of fitting a nut to the axle to secure the wheel in place.

Preferably, the method further comprises the step of applying a tackifying agent to each of the first and second cups.

Further features of the invention will become apparent from the detailed description below.

### BRIEF DESCRIPTION OF THE DRAWINGS

To assist in understanding the invention and to enable a person skilled in the art to put the invention into practical effect, preferred embodiment of the invention will be described by way of example only with reference to the accompanying drawings, in which:

FIG. 1 is a cross-sectional view of a skateboard wheel assembly according to an embodiment of the present invention;

FIG. 2 is a side view and an overhead view of the cone of the skateboard wheel assembly shown in FIG. 1; and

FIG. 3 is an exploded view of the axle, washer, cone and spacer of the skateboard wheel assembly shown in FIG. 1.

Those skilled in the art will appreciate that minor deviations from the symmetrical layout of components as illustrated in the drawings will not detract from the proper functions of the disclosed embodiments of the present invention.

### DETAILED DESCRIPTION OF THE DRAWINGS

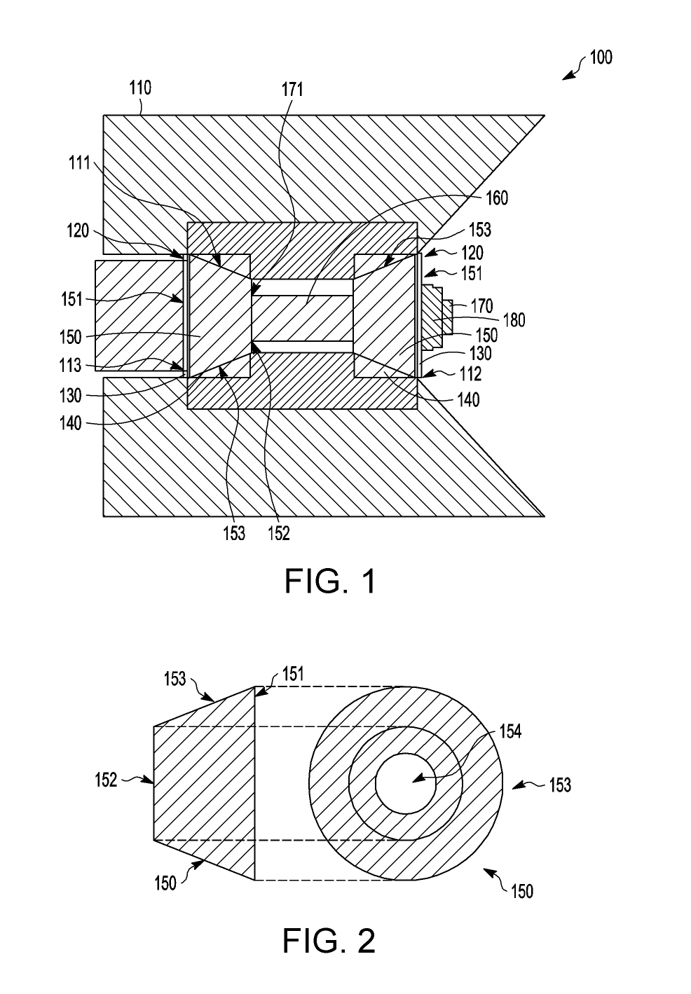

FIG. 1 illustrates a skateboard wheel assembly 100. The skateboard wheel assembly 100 includes a wheel 110 and two bearings 120 for a skateboard wheel 110. Each bearing 120 includes a thrust washer 130, a tapered cup 140 and a complementary tapered cone in the form of a frustocone 150 having a lower end 151, an upper end (or tapered end) 152 and a tapered side wall 153 extending between the lower end 151 and the upper end 152 at angle of between approximately 45° to 85° relative to the lower face.

The frustocone 150 is received within the reciprocally shaped cup 140. In some embodiments, the thrust washer 130 may also include a raised lip (not shown) at the outer edge which corresponds with the edge of the cup 140 of the bearing assembly 120.

The thrust washer 130, tapered cup 140 and frustocone 150 are typically composed of a self-lubricating polymer in the form of acetal and ertalon respectively. However, a person skilled in the art will appreciate that these elements can be composed of any suitably self-lubricating polymer.

The skateboard wheel assembly 100 further includes a spacer 160 that is mounted between the two wheel bearings 120 should the bearings 120 not meet. It will be appreciated that in some embodiments, where the two bearings 120 are of sufficient length to meet, the spacer 160 is not required.

Additionally, the skateboard wheel assembly 100 includes an axle 170 that extends through holes (not shown) in each of the wheel 110 and the two bearings 120. Fitted to the end of the axle 170 and abutting the thrust washer 130 is an axle nut in the form of a wheel securing nut 180 to secure the bearings 120 and the wheel 110 in place.

The tapered cup 140 is pressed into the bearing housing recess 111 at the centre of each end 112,113 of the wheel 110. The larger face, or lower end, 151 of the frustocone 150 faces out from the centre of the wheel 110 as shown.

In assembly, the thrust washer 130 and the frustocone 150 are fitted to the axle 170 with the tapered end 152 of the frustocone 150 facing away from the centre of the skateboard (not shown) and pushed onto the axle 170 until the frustocone 150 abuts the undercarriage (not shown) of the skateboard, from which the axle 170 protrudes on each side of the skateboard.

The cylindrical spacer 160 is fitted to the axle 170 with a first end 171 abutting the tapered end 152 of a first frustocone 150. The wheel 110 with both tapered cups 140 is then placed onto the axle 170 over the spacer 160 and frustocone 150 in such a way as to have the cup 140 nearest to the centre of the skateboard sit over and align with the tapered end 152 of the frustocone 150 on the axle.

A second frustocone 110, identical to the first frustocone 110, is fitted to the axle 170 with the tapered end 152 facing the centre of the wheel 110. This cone is pushed into a position such that the taper matches and sits into the taper of the cup 140 in the outer side of the wheel 110. A thrust washer 130 is then placed on the axle 170 abutting the cone 150 as shown. In some alternative embodiments, the thrust washer is also a seal.

The wheel securing nut 180 is threaded onto the matching threaded end of the axle 170 and rotated until the washers 130, frustocones 150 and spacer 160 press together along the axle 170 and resistance is felt as the wheel securing nut 180 is turned. This ensures that the washers 130, frustocones 150 and spacer 160 are clamped together, locking the frustocones 150 from rotating and ensuring that the cups 140 rotate on the cones 150 focusing rotational friction at this point.

In some alternative embodiments, the washers, cones and cups can comprise a combination of different polymers. In use, this combination of polymers enhances the static grip of the bearing and provides improved polymer lubrication and freer movement as speed increases.

The polymers of the bearing can also be lubricated with a suitable grease type lubricant or tackifying agent (not shown). The lubricant binds to the sheared particles of the bearing preventing some of the sheared particles from redepositing into the polymer and therefore increasing the lubricating shear layer between the components of the bearing. This increases the pressure to velocity ratio of the polymers.

FIG. 2 illustrates a side view and an overhead view of the frustocone 150 of the bearing assembly 120 described in FIG. 1. As shown, an aperture 154 extends through each of the seal 130, cup 140 and frustocone 150 for receiving the axle 170 shown in FIG. 1.

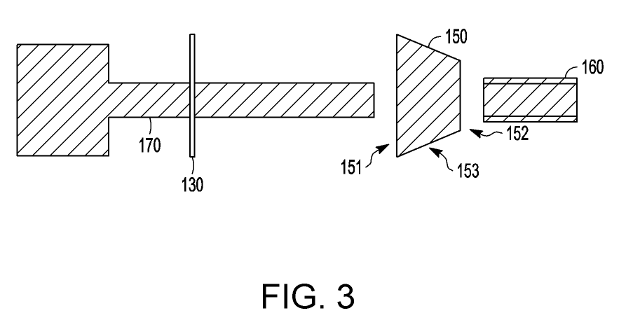

FIG. 3 illustrates an exploded view of the axle 170, washer 130, frustocone 150 and spacer 160 of the skateboard wheel assembly 100 described in FIG. 1.

Advantageously, the arrangement of the frustocones 150 and cups 140 result in a self-centering effect for the wheel when downward force is applied to the bearing 120, for example, by a rider standing on the skateboard.

Further advantageously, when weight is applied to the bearing in a stationary condition, the force of static friction, enhanced by the tapered shape having the effect of increasing surface pressure at this point, has a tendency to prevent the bearing from turning.

Further, the removal of a ball within the bearing provides increased stability of the skateboard.

Advantageously, if assembled with a raised lip of the washer running on the corresponding edge of the tapered cup, the thrust washer provides progressive reduction of friction. Much in the same manner as a fishing reel drag provides initial resistance and then breaks free and allows relatively free movement on overload. For example, the washer initially provides high levels of friction to prevent the skateboard from rolling when downward force is applied, and the friction reduces as more force is applied to the skateboard in a forward motion and thus the skateboard wheel assembly.

Advantageously, as a rider becomes more competent in riding the skateboard, the washer can be replaced with a standard thrust washer making the board easier to move and ride.

While the wheel assembly within this specification has been described with regards to a skateboard, it will be appreciated that this is for illustrative purposes only and that the wheel assembly can be used for other wheeled device, such as scooters.

Additionally the washer is interchangeable with and functions in a superior fashion to many common fishing reel drag washers.

In this specification, adjectives such as first and second, left and right, top, bottom and side, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

The above description of various embodiments of the present invention is provided for purposes of description to one of ordinary skill in the related art. It is not intended to be exhaustive or to limit the invention to a single disclosed embodiment.

As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

1. A wheel bearing comprising:
a cup;
a cone received within the cup, the cone being of a complementary shape to the cup for receiving the cup; and
a washer, the washer abutting a surface of the cone,
wherein the cup, the cone and the washer each comprise a self-lubricating polymer.

2. The wheel bearing of claim 1, wherein the washer includes a raised outer lip.

3. The wheel bearing of claim 1, wherein the self-lubricating polymer includes acetal and ertalon.

4. The wheel bearing of claim 1, wherein the cup includes a tapered inner side wall.

5. The wheel bearing of claim 4, wherein the cone includes a tapered outer side wall complementary to the tapered inner side wall of the cup.

6. The wheel bearing of claim 1, wherein the cone includes an upper and a lower face at opposed ends of the cone.

7. The wheel bearing of claim 6, wherein the cone includes a tapered outer side wall extending between the upper face and the lower face of the cone.

8. The wheel bearing of claim 1, wherein the tapered outer side wall of the cone extends from the lower face to the upper face at an angle of between 45° to 85° relative to the lower face.

9. The wheel bearing of claim 1, wherein the tapered outer side wall of the cone extends from the lower face to the upper face at an angle of between 55° to 75° relative to the lower face.

10. The wheel bearing of claim 1, wherein the tapered outer side wall of the cone extends from the lower face to the upper face at an angle of between 65° to 75° relative to the lower face.

11. The wheel bearing of claim 1, wherein the lower face of the cone abuts the washer.

12. The wheel bearing of claim 1, wherein the cone is frustoconical.

13. A skateboard wheel assembly comprising:
a wheel;
two wheel bearings diametrically opposed on two sides of the wheel, each wheel bearing including:
a cup;
a cone received within the cup, the cone being of a complementary shape to the cup; and
a washer, the washer abutting a surface of the cone,
wherein the cup, the cone and the washer each comprise a self-lubricating polymer.

14. The skateboard wheel assembly of claim 13, further comprising a spacer mounted between the two wheel bearings.

15. The skateboard wheel assembly of claim 14, wherein the spacer abuts the two wheel bearings.

16. A method for assembling a skateboard wheel comprising:
fitting a first cup into a first housing recess of a wheel;
fitting a first cone within the first cup;
fitting a first washer to the first cone, wherein the first washer abuts a surface of the first cone;
fitting a second cup into a second housing recess of the wheel, the first housing recess opposite the second recess;
fitting a second cone within the second cup, wherein the second cone abuts the first cone;
fitting a second washer to the second cone, wherein the second washer abuts a surface of the second cone.

17. The method of claim 16, further comprising the step of fitting a spacer within the wheel, wherein the spacer abuts the first cone and the second cone.

18. The method of claim 16, further comprising the step of fitting the skateboard wheel to an axle.

19. The method of claim 18, further comprising the step of fitting a nut to the axle to secure the wheel in place.

20. The method of claim 16, further comprising the step of applying a tackifying agent to each of the first and second cups.
